(19) United States
(12) Patent Application Publication
(10) Pub. No.: US 2002/0049631 A1
(43) Pub. Date: Apr. 25, 2002

(54) PROCESS, SYSTEM AND COMPUTER READABLE MEDIUM FOR PROVIDING PURCHASING INCENTIVES TO A PLURALITY OF RETAIL STORE ENVIRONMENTS

(76) Inventor: ERIC WILLIAMS, TAMPA, FL (US)

Correspondence Address: OBLON SPIVAK MCCLELLAND MAIER &, NEUSTADT PC, 1755 JEFFERSON DAVIS HIGHWAY FOURTH FL, ARLINGTON, VA, 22202

(21) Appl. No.: 09/415,065

(22) Filed: Oct. 12, 1999

(51) Int. Cl. G06F 17/60

(52) U.S. Cl. 705/14

(57) ABSTRACT

A system, process and computer readable medium for providing purchasing incentives to a plurality of retailers from a central clearing location. The plurality of retailers transmit customer identifiers and, optionally, descriptions of customer purchases to a central incentive system via a communications system. The central incentive system determines purchasing incentives based on the customer identifiers and stored information and then transmits the purchasing incentives that have been associated with the customer identifiers to the originating retail store via the communications system. The Point of Sale system in the retail store determines if the customer qualifies for an incentive and will transmit data defining applied incentives to the central incentive system. The central incentive system may transfer funds, which cover the cost of the incentive, from an account of the incentive's sponsor to an account belonging to the retailer providing the incentive. Alternative embodiments will determine qualification for incentives and apply them at the central incentive system. One embodiment will locate a central incentive system at a financial services provider and use existing communications from retailers to the financial services provider to implement the communications system.

### CROSS REFERENCES TO RELATED APPLICATIONS

The present invention is related to U.S. Pat. Nos. 4,723,212; 4,910,672; 5,173,851; and 5,612,868, U.S. application Ser. Nos. 08/663,680; and 08/622,685, U.S. application having attorney docket No. 7791-0050-25, Ser. No. 09/225,449, filed on Jan. 6, 1999; U.S. application having attorney docket No. 7791-0058-25, Ser. No. 09/323,538, filed on Jun. 1, 1999, and U.S. application having attorney docket No. 7791-0068-25, Ser. No. 09/317,110, filed on May 24, 1999, all of which are incorporated herein by reference.

### BACKGROUND OF THE INVENTION

1. Field of the Invention

This invention relates generally to interconnected computer systems and, more particularly, to computer systems used to interconnect a plurality of retail store environments for use in the dissemination of promotions and/or incentives.

2. Discussion of Background

Providing purchasing incentives to encourage people to purchase products or patronize particular businesses has long been a successful method of product marketing. Purchasing incentives as used herein comprise offers given to people whereby the person will receive a benefit if he or she purchases a particular product or uses a particular service. The most common incentive is a discount on the purchase of a specified product or service. Some purchasing incentives have required the person receiving the offer to present a certificate entitling the bearer to obtain a benefit. The certificate most often used is a paper coupon which a customer may present to a cashier in order to receive a discount on a purchase of a specified product or service.

Some purchasing incentives are currently offered to individuals that provide the benefit to the individual when the individual makes a predetermined qualifying purchase and present a form of personal identification. These purchasing incentives are often referred to as electronic incentives because they are usually implemented with an electronic processing system that does not require printing of a coupon to evidence that the customer is eligible for the benefit of the incentive. Some of these incentives are currently offered from automated Kiosk-based units which allow the customer to present an identification and select incentives. The customer then presents the same identification during purchase of some product and, if the terms of the incentive provided at the Kiosk to the customer are satisfied, he or she automatically receives the benefit associated with the incentive in conjunction with the checking out procedure for the purchase of products. Another form of purchasing incentives that utilize customer identification are purchaser rewards points programs whereby the customer earns points based upon purchases and these points may be accumulated over time and then redeemed for items of value. While purchaser rewards points programs may be viewed as nothing more than electronic green stamps, they are finding favor with retailers and continue to grow in usage.

Prior electronic incentive systems have been implemented for shoppers using a single store or a specific chain of stores owned by the same company. These systems require the purchaser to present identification, such as frequent shopper cards provided by the company owning the store and containing the identification of the customer in a format specified by the company, and which identifications are only recognized by the retail stores of that company.

### SUMMARY OF THE INVENTION

One object of the present invention is to provide a novel process, system and computer readable medium for providing electronic incentives directly to a plurality of point-of-sale (POS) systems located at a plurality of retailers's stores.

Another object of this invention is to provide a novel process, system and computer readable medium for providing electronic incentives directly to a plurality of POS systems from a plurality of systems external to retail stores.

A further object of this invention is to provide a novel process, system and computer readable medium for allowing members of the public to accept offers for an electronic incentive from a centralized system which then allows the members to receive the benefit of the incentive directly through POS systems located in a plurality of retailers.

Another object of this invention is to provide a novel process, system and computer readable medium for enabling providing electronic incentives directly to the public who may then receive the benefit of the incentive at a POS systems located in a retailer store.

The above and other objects are achieved according to the present invention by providing a new and improved system, process and computer readable medium for storing purchasing incentives at a centralized incentive system connected to a communications network that is further connected directly to a plurality of POS systems. The POS systems may be located at checkout stations within a conventional retail store. The POS system may also be part of an Internet based retail facility, such as a World Wide Web site of a retailer. The centralized incentive system stores individualized purchasing incentives in association with each customer or a class of customers eligible for them. When a customer is making a purchase at a POS station associated with a POS terminal in one of the plurality of POS systems, that customer's identification is communicated from the POS system to the centralized incentive system. POS systems located in unrelated retail stores may be enabled to communicate customers' identifications to the centralized incentive system. Based upon the customer identification that it receives, the centralized incentive system determines for which incentives that customer is eligible. The centralized incentive system performs processing to determine if the customer qualifies for incentives for which the customer is eligible. In addition, the purchase data received by the centralized incentive system contains an address indicating where the data came from, which enables the centralized incentive system to direct communications back to the originating POS system and, ultimately, the POS terminal at the station where a customer is making a purchase involving the purchase data.

The centralized incentive system may send to the POS system, in association with the customer's identification, a description of incentives for which the customer is eligible to enable the POS system, in order to enable the POS system determine if the customer qualifies for the benefit of the incentive (e.g., by having made qualifying purchases). Alternatively, the centralized incentive system may receive, in association with the customer's identification, a description of purchases from the POS systems and then determine both whether the customer is eligible for an incentive and if the customer qualifies for the benefit of the incentive (e.g., by having made qualifying purchases).

POS systems which determine if incentive benefits are to be given to the customer further communicate to the centralized incentive system descriptions of incentive benefits given to customers. This communication enables the centralized incentive system to account for the benefit by transferring funds from an account for a sponsor of the incentive to an account for the provider of the benefit, in order to compensate the provider and debit the sponsor of the benefit for the cost of the benefit given to the customer.

The centralized incentive system similarly transfers funds for benefits determined by the centralized incentive system. The transfer of funds may be implemented by automatically and instantly debiting the account of the incentive's sponsor and crediting the account of the retailer for the cost of the incentive given to the customer.

### BRIEF DESCRIPTION OF THE DRAWINGS

A more complete appreciation of the invention and many of the attendant advantages thereof will be readily obtained as the same becomes better understood by reference to the following detailed descriptions when considered in connection with the accompanying drawings, wherein:

FIG. 1 is a top level system diagram for distributing purchasing incentives to a plurality of retailers;

FIG. 2 is a top level flow chart illustrating a method for distributing purchasing incentives to a plurality of retailers in the system of FIG. 1; and

FIG. 3 is a top level flow chart illustrating a method for distributing purchasing incentives, tracking purchases and applying discounts from a centralized system as illustrated in FIG. 1.

### DESCRIPTION OF THE PREFERRED EMBODIMENTS

The preferred embodiment of the present invention comprises a computer network system that provides electronic incentives to customers. The includes connections to multiple store POS systems that each have at least one conventional POS terminal or an Internet site enabling electronic financial transactions. The system of the present invention stores in a database in association with one another an identification of a customer and the prerequisites for the customer to obtain the benefit associated with the incentive. That is, the database stores the purchase specification, which includes the products or services which must be purchased in association with the customer's identification as a prerequisite for giving the purchaser the benefit associated with the incentive, the customer identification, and the benefit. In addition, the database may store, and purchase specification may also include the sponsor's account to be debited and the retailer's account to be credited, and the amounts to debit and credit.

An electronic incentive may be automatically stored in association with the customer's identification without assent by the customer once the incentive is offered to the customer. No act of acceptance on the part of the customer, prior to qualification, is necessary. The customer may accept the offer by purchasing the product or service identified in the specification as the prerequisite to obtaining the benefit of the offer. However, some embodiments of the present invention require the customer to respond to a query or other communication, by indicating in their response a desire to accept the incentive offer, in order to have the electronic incentive associated with his or her identification.

The incentive specification is stored in a computer database and is retrieved as a customer makes a purchase at a POS station. The purchase specification of an incentive specification may define a prerequisite to providing the benefit to be: a purchase of a particular product, e.g., any size box of Brand X Cereal; a minimum total purchase amount, e.g. any purchase over $100; a purchase of a combination of products (of the same or different brands), e.g. Brand X sugar and Brand X cereal. If the customer makes such a purchase, he or she will receive the benefit defined by the incentive specification. The benefit of an electronic incentive may be a discount on the purchase price of a specified item when that item is purchased. The benefit of an electronic incentive may also be a discount contingent upon the present or future purchase of another product. The benefit of the electronic coupon may be a paper coupon, printed at the POS, which coupon provides a discount or a free product from the same retailer or service provider from which the customer's present purchase is being made or from a different retailer or service provider as the one from which the customer's present purchase is being made.

One method of offering individualized electronic incentives is to require the customer to present his or her identification in conjunction with the offer, such as with offers made through an automated Kiosk at which the customer is required to present his or her identification, or, as with offers made through world wide web (Web) sites, by requiring the customer to transmit an identification number into the Web site.

An individualized electronic incentives need not be offered to a customer only at a the time of sale, and need not be offered to a customer only while the customer is at a POS station. Instead, an individualized incentive may be offered to a customer whose identification and contact information (address or email address or personal Web site) are known. For example, a communication may be sent to the customer by direct postal mail (or email) indicating an incentive offered to the customer, if the customer has an identification in a frequent shopper club card, in which case the purchase specification/incentive specification may be stored in the database in association with the customers frequent shopper club identification. The customer may qualify for the benefit of the incentive offer by providing his or her frequent shopper card identification at a checkout station and meeting the other prerequisites of the incentive offer.

A sponsor of a promotion using electronic incentives may also define classes of customers to receive particular electronic incentives. Examples of classes of individuals whom may be offered an electronic incentive include customers who make in excess of a specified amount of purchases from a specific retailer or by using a specified credit card each month. Determination whether a customer is a member of a class may occur when a customer is at a POS station, and may be based upon identification provided by the customer. The identification can be a frequent shopper card, credit card, bank card, check, etc. A class may also be defined by other criteria and the identification used by the class may be determined through other means. An example of this latter case would be offering a discount to users of a particular credit card (i.e., based upon the instrument used to make the purchase) and/or who are residents of a particular geographic area. This promotion could be implemented by determining the credit card company based upon the credit card numbers, and by determining the geographic residence information from the credit card company's record or the card holder's address.

Electronic incentive offers may also be made available to all customers. This is similar to providing a mail in rebate offer for the item. However, providing an automatic incentive at the POS and time of sale of the item is more enticing to customers since no further effort is required on their part as with mail-in rebates. The present invention may provide electronic discounts whenever a particular product is being purchased from a store of any one of a number of retail companies. This allows the customer to choose the retail store to shop at. This also enables manufacturers to provide an “instant rebate” promotion to the purchaser of the specified product without requiring the participation of the retailers in the promotion.

A POS system which provides individualized electronic incentives identifies customers who are making purchases by reading an identification recognized by the POS system in conjunction with the customer's purchase. The POS system applies a benefit identified in an electronic incentive to a customer's purchase order if the customer has presented identification and if that customer has been offered the incentive and met the prerequisite of the offer. Retailers may use several techniques to identify a customer, including reading a frequent shopper club card that has a membership number encoded into a printed bar code, reading a customer's credit card or bank debit card number, or measuring a customer's biometrics as is well known to practitioners in the art.

An example of a promotion program that a household paint manufacturer would like to be able to institute and which the system provided by this invention enables is an electronic incentive offered through nationwide advertising of a one dollar discount credited against the customer's purchase price at checkout at the time of purchase.

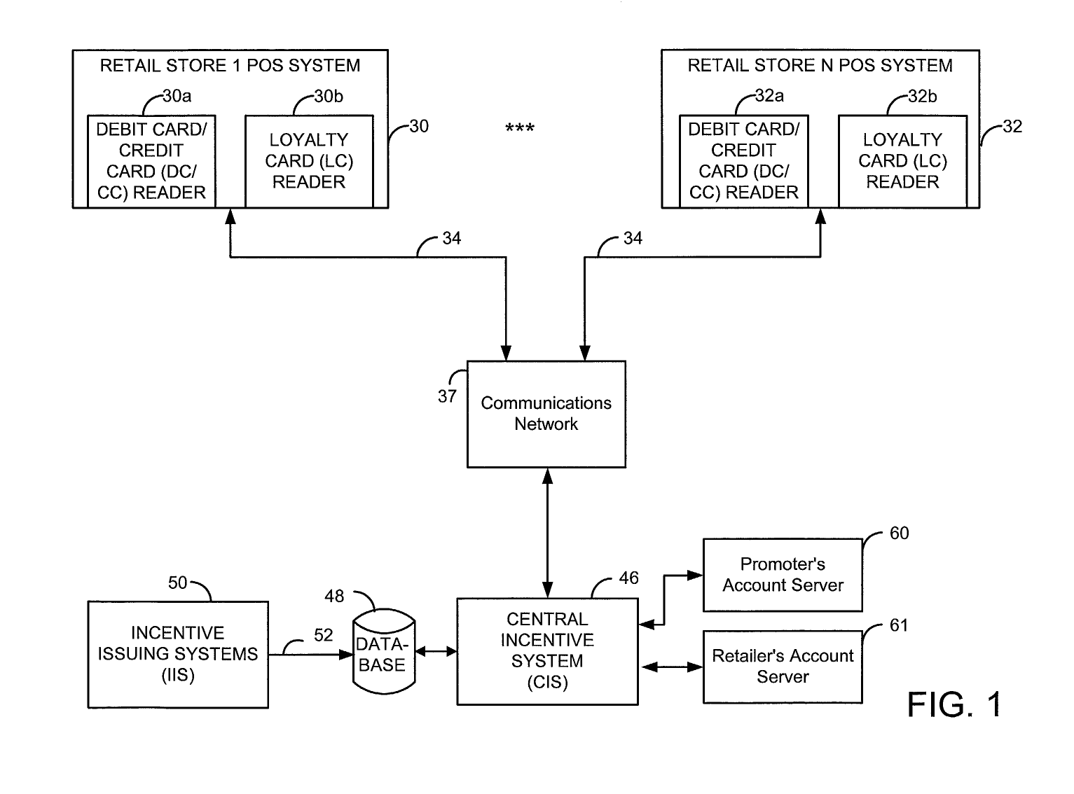

Accordingly, the present invention transcends the single retail store and single retail store chain electronic incentive concept and automatically provides the capability to offer and process cross-chain or cross-industry electronic incentives. The present invention, as will be described with respect to FIGS. 1-3, provides a system that offers customers incentives through the Internet, T.V. broadcasts, direct mail, etc., while the customer is at home, in a store or elsewhere and then allows that customer to automatically receive the benefit of the incentive at their choice of retailer, which choice may include conventional retail stores or Internet retail facilities.

FIG. 1 is a top level system diagram for a system that distributes electronic incentive information to a plurality of retail stores, which retail stores are not required to be in a specific store chain. The system illustrated in FIG. 1 utilizes POS systems found in conventional retail stores. It is to be understood that the present invention will work equally well with electronic transaction systems that are part of an Internet retail facility, such as a World Wide Web retailer. The electronic transaction systems that are part of an Internet retail facility are referred to herein as POS systems for convenience, unless context specifically dictates otherwise.

In FIG. 1, a plurality of retail stores 1 . . . N, for example, retail stores 30 and 32 are coupled to a central incentive system 46 through a real time communications network 37. Each retail store, for example, retail store 30 includes at least one POS system having a customer identification reader, which may be a debit card and/or credit card reader and/or drivers license reader 30a and/or a loyalty card reader 30b. Similarly, retail store 32 includes at least one point-of-sale system having a debit card and/or credit card reader 32a and/or drivers license reader and/or a loyalty card reader 32b. It is to be understood that the customer identification devices mentioned above may be performed by hardware used to also perform other functions. For example, loyalty cards with optically read printed bar codes may be read by the bar code scanner used to read bar codes printed on purchased products.

The following description will use retail store 30 to represent a specific example of a retail store in describing the operation of a preferred embodiment of the system of the present invention. It is to be understood that other retail stores, e.g. retail store 32 in FIG. 1, will operate similarly. FIG. 1 shows that the retail stores are coupled to a communications network 37. The communications network 37 allows data to be rapidly communicated in real time and may include one or more of network connections, wireless connections, telephone connections, modem connections, etc., as will be apparent to those skilled in the electronics and communications arts.

The communications network 37 is further coupled to a central incentive system (CIS) 46. For clarity of illustration, FIG. 1 shows only 1 CIS 46. It is to be understood that the present invention may operate with multiple central incentive systems that may each be in communication with the plurality of retail stores through the same or separate communications systems. The CIS 46 is further coupled to a database 48 which stores electronic incentives associated with identification of each customer. The database 48 stores electronic incentive specifications and incentive offers stored in association with unique customer identifications corresponding to identifications encoded on customers' debit cards, credit cards, loyalty cards, drivers licenses, etc., using conventional methods as are known in the art.

Data is provided to the database 48 by the incentive issuing systems (IIS) 50. The IIS 50 may operate in conjunction with multiple automatic and operator driven incentive offering systems. The IIS 50 may operate with an Internet based system incentive offering system, such as a World Wide Web site that allows a user to enter user/customer identification. The IIS 50 may also operate with automated Kiosks located in retail stores or other locations that allow customers to select electronic incentive offers. Such an automated Kiosk includes a display and a customer identification reader allowing the Kiosk to determine the customer's identification and transmit electronic incentive data identifying what was offered to the customer in association with the customer identification data to the IIS in order for the IIS to store the electronic incentive into database 48.

The IIS 50 may also operate with systems that allow viewers of television advertisements to respond by either by using a calling a toll free telephone number or by sending an acceptance of an offer as a transmission from digital set-top box having the capability to transmit information. A television advertisement may instruct viewers to call a toll free telephone number in order to provide identification information which will be used to store the electronic incentive electronic incentive in association with the identification. A digital set-top box may be used in television systems that support bi-directional communication to a central location with an IIS facility. The digital set top box allows the viewer of a television advertisement to select and send responses to the central location, and ultimately to the IIS, in response to instructions given on the television advertisement. The digital set-top box may be programmed to store customer identification information, thereby obviating the requirement for the television user to enter the information, or the digital set top box may support entry of identification information. In this way, a customer may select, for example, incentives via the Internet or T.V. and receive a credit at the retail store 30 when he or she makes the required purchase.

The IIS 50 stores information on offered incentives in the database 48.

Based upon the data read from database 48 and purchase data received from the communications network 37, the CIS 46 determines benefits to provide to customers. The purchase data received from the communications network 37 may contain identification of the products being purchased, value of the purchase, and does contain a customer identification.

The POS system for store 30 may further send a customer qualifying action specification to the CIS 46, through either the same or an alternative communications network. One type of customer qualifying action specification may describe incentive benefits applied to the customer by the POS system, such as discounts applied to the customer's purchase as a result of the customer's qualifying purchases. Providing qualifying purchase and applied benefit information to the CIS 46 allows tracking of customer selections, accumulation of shopping histories at the CIS 46 and real time, automated accounting and billing for the incentive benefits given to customers. Other customer qualifying action specifications may contain a description of all items the customer has selected for purchase, allowing the CIS 46 to determine for which incentive benefits the customer qualifies and further allowing the CIS 46 to accumulate more detailed shopping histories.

Embodiments of the present invention which include POS systems that return customer qualifying action specifications to the CIS 46 allow automatic and real time accounting of the incentives provided to customers as well as automatic and real time funds transfer corresponding to the cost of the incentive. Incentives or other items of value provided to customers by the present invention are often paid for by promoters of products or services who are providing the incentive in order to promote, for example, the product which must be purchased in order to receive the benefit of the incentive The promoter sponsoring an incentive will pay the retailer for the cost of the benefit given to the customer in order to compensate the retailer for the value given to the customer. The present invention allows automated and real time transfer of funds from the promoter to the retailer in order to pay for the incentive.

FIG. 1 illustrates that the CIS 46 communicates with a promoter account server 60 and a retailer account server 61. The promoter account server 60 is a financial service provider, such as a bank or electronic payment clearing facility, that maintains an account balance for each promoter sponsoring an electronic incentive provided by the CIS 46. The retailer account server 61 is a similar financial service provider that maintains a credit balance accumulated by each retailer providing electronic incentives to customers. When an incentive benefit is given to a customer, the CIS 46 will debit funds from the account corresponding to the promoter's account maintained on the promoter's account server 60 that correspond to the discount and credit these funds to the retailer's account maintained on the retailer's account server 61. The retailer will have immediate access to the funds credited to the retailer's account shortly after the discount is applied to the customer's purchase.

Alternative embodiments of the present invention may also communicate the entire customer purchase selection list from the POS system 30 to the CIS 46. This allows the CIS 46 to determine which incentive benefits to apply given the customer's purchase selections and the CIS 46 may also apply incentive benefits itself as opposed through the retail store POS system 30. This form of operation further allows accumulation of the customer's purchase selection over multiple shopping trips. This accumulated shopping history may be stored in database 48 in association with the customer's identification. The IIS 50 may access the accumulated shopping history in database 48 to determine further incentive to offer to the customer based on that customer's demonstrated purchasing preferences. The customer purchase selection data accumulated into database 48 may further be analyzed to determine marketing statistics such as identifying the types of offers customer's generally accept and statistics identifying the correlation between the acceptance of different types of offers by the same person. It should be noted that, although the IIS 50 and CIS 46 are shown as separate elements, they me be separate processes performed on a single computer or separate computers both accessing database 48.

The present invention may communicate customer purchase selections from the POS system of store 30 to the CIS 46 through (1) the real time communications network 37 used to communicate customer's identification and incentives to apply between the POS system 30 and the CIS 46, (2) another real time communications channel, or (3) an alternative, non-real time communication channel.

Alternative, non-real time communications channels include architectures which accumulate purchase selection data at the retail store and periodically communicate this accumulated data to the CIS 46. These other communications channels may include dial up modems or other part time digital links. The present invention may operate with non-real time communication of customer purchase selection data since most promotions which use shopping history may be adapted to allow a short delay in crediting the benefit to the customer after the qualifying purchases are made.

Embodiments of the present invention which communicate the entire customer purchase selection list from the POS system 30 to the CIS 46 may implement a real-time purchaser reward points system. A purchaser reward points system is a promotional program whereby customers are given and accumulate points for making purchases and the accumulated points may be traded for value. The present invention allows the CIS 46 to determine the points earned by each purchase (by comparing the description of products purchases to a table of points for each qualifying products) and credit these points to the customers account maintained in database 48. In addition to accumulating points, the present invention can streamline and make more efficient the operation of a purchaser reward points system by providing coupons to customers who have accumulated a specified number of points. The coupon could entitle the holder to a free product or a specified incentive applied to a future purchase. The coupon may be printed by sending a print command to a coupon printer collocated with the POS system.

The present invention may be implemented with a system that utilizes communication equipment and information processing already in place in major retail stores. An embodiment of the present invention may implement the communications network 37 through the use of the infrastructure that is already in place in major retailers to communicate financial information between the individual retail stores and financial systems. Most major retail store chains have leased telecommunication lines connecting each of their stores to a central office. The central office, in turn, has dedicated communications to and from financial systems such as credit card authorization networks and financial institutions to support verifying payment by debit card or checks. These dedicated communications operate continuously and are used to communicate either credit card information to credit card authorization networks in order to facilitate validation of credit cards or to communicate bank debit cards and personal checks information to appropriate financial institutions to validate these payment instruments.

An embodiment of the present invention may use the excess capacity of the existing full time communications equipment between the retail stores and financial systems to allow automatic distribution of electronic incentive specifications from a centrally managed database that is collocated with one or more of the financial systems.

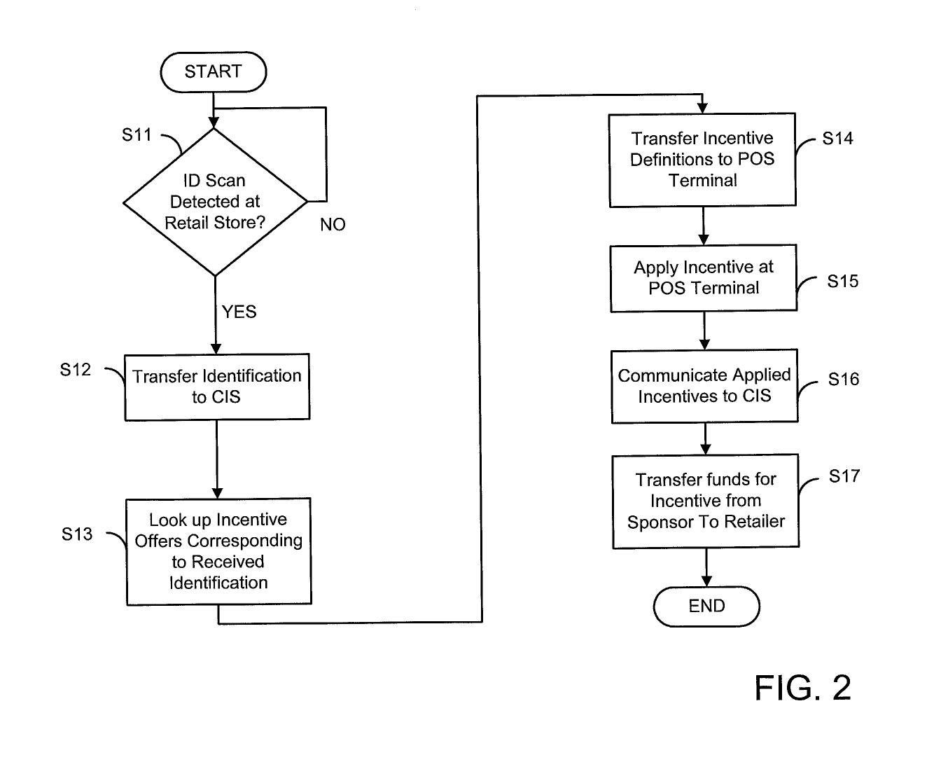

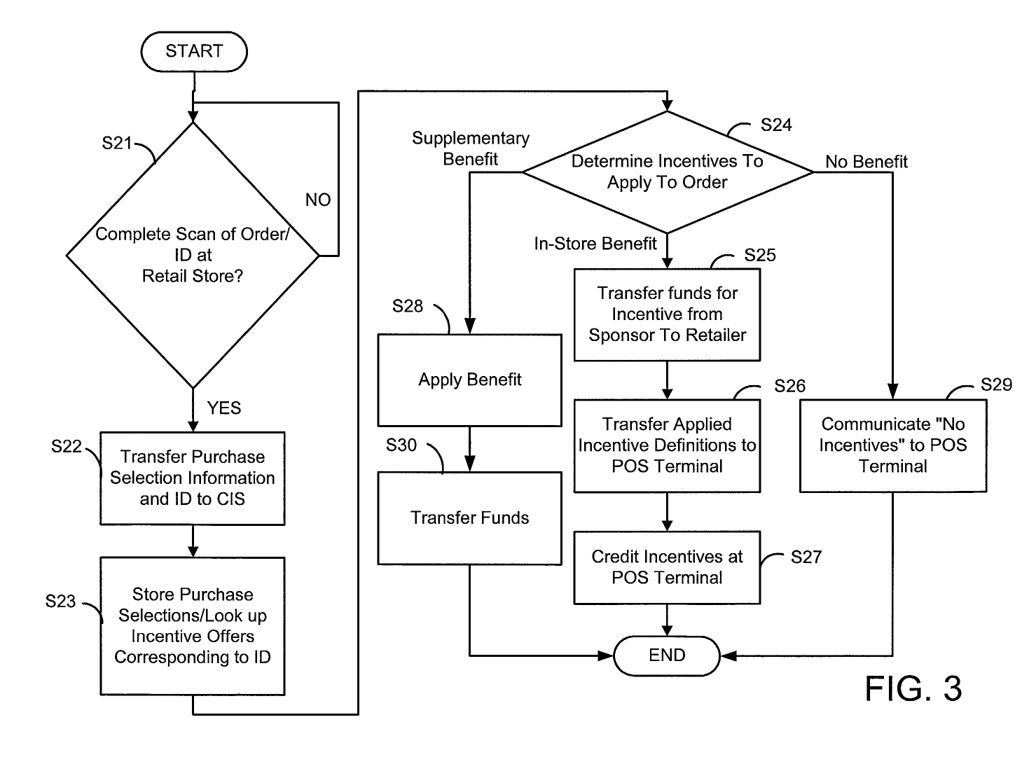

The operation of the system of FIG. 1 will now be described with reference to the flow charts shown in FIGS. 2 and 3. The processing described in FIG. 2 involves an embodiment which only provides to the CIS 46 the customer's identification, optional purchase amount and a customer qualifying action specification which contains an identification of incentive benefits given to the customer. The processing of FIG. 2 starts with the detection, at step S11, of the scan of a customer's identification, which may be a credit card, debit card, or loyalty card at a POS station located in any one of the retail stores implementing the present invention. The customer's identification is read by one of the card readers (e.g., 30a, 30b, 32a and 32b of FIG. 1). This detection would typically occur when a customer presents his or her credit card, debit card or loyalty card at a point-of-sale system of a retail store 30, 32 to complete a transaction.

At step S12, the customer's identification information is transferred to the central incentive system (CIS) 46 through the communications network 37. The information transmitted to the CIS 46 will also include a unique retail store and point-of sale system identifier to allow the CIS 46 to properly direct responses to the proper POS system. Some embodiments may also transmit the total dollar amount of the purchase to allow the CIS 46 to further identify if the customer's purchase qualifies for an incentive offer.

At step S13, a programmed processor of the CIS 46 determines if any purchasing incentives associated with the transmitted customer's identification are stored in database 48. If there are purchasing incentives associated with the customer's identification that is received by the CIS 46, the CIS 46 will prepare a description of these incentives for transmission to the originating POS system. Some incentives stored in database 48 may require that a minimum total purchase amount be made. If the CIS 46 receives the total purchase amount information with the customer's identification, that data may be used to further identify incentives which should be sent to the POS system, i.e. if the total purchase amount is less than that specified for an incentive, a description of that incentive will not be returned to the POS system. The CIS 46 will then transmit these incentive descriptions to the originating POS system through communications network 37 in step S14.

At step S15, the retail store completes the customer's transaction by determining if the customer has made any purchases satisfying the incentive descriptions transmitted from the CIS 46 and provide the benefits, such as applying a discount or printing a coupon, of any incentive specifications the customer has satisfied.

At step S16, the POS system 30 will communicate to the CIS 46 a description of any incentive benefits applied to the customer's purchase. This description may specify the amount of any discounts applied to the customer's purchase based upon qualifying purchases, or may describe coupons printed by the POS system and given to the customer for future purchases. This description will also include an identification of the incentive offer or the purchase which satisfied an incentive offer to allow the CIS 46 to automatically transfer funds from the sponsor of the incentive offer to the retailer that applied the benefit.

Finally, in step S17, funds equivalent to the benefit are transferred from the promoter's account maintained on the promoter's account server 60 to the retailer's account maintained on the retailer's account server 61 in order to compensate the retail store for the incentive applied to the customer's purchase.

The processing in FIG. 3 illustrates the operation of a more complex embodiment of the present invention which communicates customer qualifying action specifications that include a full description of all customer purchase selections to the CIS 46 in order to support more flexible application of incentives to customer's accounts. The processing illustrated in FIG. 3 also operates on an embodiment of the present invention which uses real time communications for all information communicated between the retail stores and CIS 46.

In step S21, the POS system accumulates information describing the items a customer has selected for purchase and also determines the customer's identification. Once the POS system has assembled this information, the POS system formats this information as required by the particular embodiment and initiates its transmission to the CIS 46. In addition to a description of the purchase selections and customer identification, the POS system will also transmit a unique retail store and point-of sale system identifier to allow the CIS 46 to properly address reply information and credit the retailer's account.

At step S22, this transaction information is transferred to the central incentive system (CIS) 46 via the communications network 37.

At step S23, a programmed processor of the CIS 46 stores the purchase selections into database 48 and retrieves from database 48 prior purchase selections stored in association with that customer's identification as well as and descriptions of purchasing incentives which have been stored in association with the customer's identification. The CIS 46 may be programmed to determine further incentives to offer the customer based upon the customer's accumulated shopping history. An example of this type of programming would provide an incentive offer to a one dollar discount on the purchase of potato chips to any customer who purchases ten bottles of a specified soda over any number of shopping trips. If a customer has purchased nine bottles in prior trips and purchased one more this trip, the incentive offer for a one dollar discount on potato chips will be sent to the POS system.

The programmed processor of the CIS 46 will next compare the purchase selections received from the POS system with the retrieved incentive specifications in step S24 to determine if the customer is to receive a benefit. The present embodiment may reach three determinations concerning which benefit to give to the customer. The CIS 46 may determine that (1) no benefit is to be provided, (2) that the customer is to receive an in-store benefit, such as a discount to be applied to the current purchase, or (3) the customer has satisfied the requirements of an incentive and is to receive a supplementary benefit, which is a benefit provided to the customer without the involvement of the retailer. A customer may qualify for multiple in-store or supplementary benefits, or a combination of both in-store and supplementary benefits. It is to be understood that the processing described below for both of these benefits may be performed for multiple benefits or for both types of benefits in response to a single purchase.

If the CIS 46 determines that the customer does not qualify to receive the benefit of an incentive, processing continues with step S29. In step S29, some embodiments will require the CIS 46 to communicate a message to the POS system that no benefit is to be applied. Other embodiments may not require a message to be communicated to the POS system.

If the CIS 46 determines that a supplementary benefit is to be provided to the customer, the processing will continue with step S28 where the benefit is applied. One type of supplementary benefit provided by the present invention are incentives for the purchase of a product which are given to the customer by applying a credit to the customer's credit or debit card.

In step S30, funds equivalent to the benefit to be credited to the customer are transferred from the promoter's account maintained on the promoter's account server 60 to the retailer's account maintained on the retailer's account server 61 in order to compensate the retail store for the incentive to be applied to the customer's purchase.

If an in-store benefit is to be provided to the customer, the processing will continue with step S25. In step S25, funds equivalent to the benefit are transferred from the promoter's account maintained on the promoter's account server 60 to the retailer's account maintained on the retailer's account server 61 in order to compensate the retail store for the incentive to be applied to the customer's purchase.

At step S26, the CIS 46 formats and transfers to the POS system a description of benefits, such as incentives, to apply to the customers purchase.

At step S27, the retail store completes the customer's transaction by applying the benefit, such as subtracting an incentive amount from the customer's purchases.

It is noted that the in-store and supplementary benefits provided to customers may be further stored in a database 48 and analyzed or processed to perform auditing, accounting and billing operations.

It will be appreciated from the foregoing that the present invention represents a significant advance in the field of retail store computer systems. In particular, the invention provides a centralized administration of electronic incentives through a system that is not related to a store chain.

The mechanisms and processes set forth in the present description may be implemented using a conventional general purpose microprocessor (e.g., the programmed processors included in the CIS 46 and IIS 50) programmed according to the teachings in the present specification as will be appreciated to those skilled in the relevant art(s). Appropriate software coding can readily be prepared by skilled programmers based on the teachings of the present disclosure, as will also be apparent to those skilled in the relevant art(s). However, as will be readily apparent to those skilled in the art, this invention may also be implemented by the preparation of application-specific integrated circuits or by interconnecting an appropriate network of conventional component circuits.

Although the preferred embodiment of the invention is described in terms of POS systems having a debit card and/or credit card and/or drivers license reader 30a and/or a loyalty card reader 30b to verify a customer's identity, various other types of devices, such as smart card readers, retinal scan readers, fingerprint analysis readers, voice analysis readers, image analysis readers, etc., may be provided to verify the customer's identity, by including appropriate hardware/software in the POS system, as will be apparent to those skilled in the relevant arts.

The present invention thus also includes a computer-based product which may be hosted on a storage medium and include instructions which can be used to program a microprocessor to perform processes in accordance with the present invention. This storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by letters patent of the U.S. is:

1. A computer network system, comprising:
a central incentive computer system;
a database of outstanding offers associated with said central incentive computer, said database of outstanding offers for storing a specification of an incentive offer in association with a customer identification;
a database of offer selection criteria associated with said central incentive computer, said database of offer selection criteria storing criteria for qualifying for said incentive offer;
a retail POS system comprising means for transmitting to said central incentive computer system said customer identification in association with purchase data and an electronic address indicating origination of the associated customer identification and purchase data;
said central incentive computer system comprising means for receiving said customer identification in association with purchase data and an electronic address indicating origination of the associated customer identification and purchase data;
said central incentive computer system comprising means for providing an offer determination by determining if said purchase data satisfy said selection criteria;
means responsive to said offer determination for updating said database of outstanding offers to store said specification of said incentive offer in association with said customer identification;
said central incentive computer system comprising means for providing a benefit determination by determining if said purchase data satisfy an outstanding offer associated with said customer identification stored in said database of outstanding offers; and
said central incentive computer system comprising means for transmitting, in response to said benefit determination, an indication of said benefit to said address indicating origination of the said associated customer identification and purchase data.

2. The system of claim 1 further comprising:
a database of accounts associated with said central incentive computer, said database of accounts for storing an account for a retailer identifying credits due to said retailer and an account for a promoter identifying debits owed by said promoter; and
said central incentive computer system comprising means for crediting said account of said retailer and debiting said account of said promoter.

3. The system of claim 1 wherein said retail POS system and said central incentive computer system communicate over a communications system comprising at least one member of the group consisting of network connections, Internet connections, wireless connections, telephone connections, and modem connections.

4. The system of claim 1 wherein said selection criteria comprise value of a purchase identified in said purchase data.

5. The system of claim 1 wherein said retail POS system comprises means for applying said benefit to a purchase associated with said customer identification and said purchase data.

6. The system of claim 5 wherein said benefit is a coupon printed by said retail POS system.

7. The system of claim 5 wherein said benefit is a discount applied to said purchase.

8. The system of claim 1 wherein said retail POS system comprises means for determining said customer identification from one of a debit card reader, credit card reader, drivers license card reader, loyalty card reader, smart card reader, retinal scan reader, fingerprint analysis reader, voice analysis reader, and image analysis reader.

9. The system of claim 1 wherein said central incentive computer system is collocated with a financial system and said retail POS system communicates with said central incentive computer system through a communications system linked to said financial system.

10. The system of claim 9 wherein said financial system includes a credit authorization system for authorizing credit to a customer and a financial institution for debiting a customer's financial account in response to said benefit determination.

11. The system of claim 1 further comprising an incentive issuing system coupled to said central incentive computer system, wherein said incentive issuing system can transmit a purchasing incentive specification to said central incentive computer system.

12. The system of claim 11 wherein said incentive issuing system and said central incentive computer system communicate over at least one member of the set of network connections, Internet connections, wireless connections, telephone connections, and modem connections.

13. The system of claim 11 wherein said incentive issuing system supports manual entry of purchasing incentive specifications.

14. The system of claim 11 wherein said purchasing incentive specification is associated with a customer identification.

15. The system of claim 14 wherein said incentive issuing system has means to receive a signal transmitted from a transmitting television set top box.

16. The system of claim 11 wherein said incentive issuing system notifies an individual associated with said customer identifier of purchasing incentive offers via an Internet service.

17. The system of claim 16 wherein said Internet service comprises a world wide web site.

18. The system of claim 16 wherein said Internet service comprises electronic mail.

19. The system of claim 11 wherein said incentive issuing system further comprises means for transmitting said purchasing incentive specification in response to a non Web based transmission and a request for a Web page associated with a customer identification.

20. The system of claim 11 wherein said incentive issuing system comprises means for selecting promotional incentives to offer based upon a shopping history stored in association with said customer identification.

21. The system of claim 11 wherein said incentive issuing system comprises means for selecting promotional incentives to offer based upon a history of use of an automated kiosk associated with said identification number.

22. The system of claim 11 wherein said purchasing incentive criteria is associated with a class of customers.

23. The system of claim 22 wherein said class comprises customers with residences in a certain geographic area.

24. The system of claim 22 wherein said class comprises customers making a specified amount of purchases in a specified time period.

25. The system of claim 22 wherein said class comprises customers who have not made purchases during a specified time period.

26. The system of claim 1 wherein said central incentive computer system further comprises means for transferring funds between a retailer's account and a promoter's account, wherein said means to transfer funds operates to transfer a value of incentive benefits provided to a customer from said promoter's account to said retailer's account.

27. The system of claim 1 wherein said selection criteria comprises purchase of a product.

28. The system of claim 1 wherein said selection criteria comprise purchase of a specified combination of products.

29. A system for providing purchasing incentives, comprising:
a central incentive computer system, said central incentive computer system comprising:
i) a database storing purchasing incentive specifications:
ii) means for determining purchasing incentives to provide to a customer based upon a customer identifier associated with said customer and information stored in said database
and
iii) means for applying a benefit associated with said purchasing incentives to said customer;
and
a plurality of retailer POS systems, wherein one or more of said plurality of retailer POS systems are not part of a single retail chain and wherein at least one of said plurality of retailer POS systems comprises:
i) customer identification means operating to determine said customer identifier,
ii) means for generating an electronic description of customer purchase selections,
and
iii) means for communicating to said central incentive system said electronic description of customer purchase selections.

30. The system of claim 29 wherein said benefit is a credit of purchase reward points credited to said customer, said purchase reward points based upon said electronic description of customer purchase selections.

31. The system of claim 29 wherein said benefit is a credit applied to a payment account associated with said customer.

32. The system of claim 29 wherein said central incentive system further comprises means for transferring funds between a retailer's account and a promoter's account; and wherein said means to transfer funds operates to transfer a value of promotions provided to a customer from said promoter's account to said retailer's account.

33. A system for providing purchasing incentives, comprising:
a central incentive computer system, said central incentive computer system comprising a database and further comprising
i) means for selecting purchasing incentives to provide to a customer based upon a customer identifier associated with said customer and information stored in said database
and
ii) means for transmitting said purchasing incentives to a plurality of retailer POS systems;
and
wherein one or more of said plurality of retailer POS systems are not part of a single retail chain and at least one of said POS systems comprises customer identification means for determining said customer identifier.

34. A computer process, comprising:
storing a specification of an incentive offer in association with a customer identification in a database of outstanding offers associated with a central incentive computer;
storing criteria for qualifying for said incentive offer in a database of offer selection criteria associated with said central incentive computer;
transmitting to said central incentive computer system said customer identification in association with purchase data and an electronic address indicating origination of the associated customer identification and purchase data from a retail POS system;
receiving said customer identification in association with purchase data and an electronic address indicating origination of the associated customer identification and purchase data at said central incentive computer system;
providing an offer determination by determining if said purchase data satisfy said selection criteria at said central incentive computer system;
updating said database of outstanding offers to store said specification of said incentive offer in association with said customer identification in response to said offer determination;
providing a benefit determination by determining if said purchase data satisfy an outstanding offer associated with said customer identification stored in said database of outstanding offers at said central incentive computer system; and
transmitting, in response to said benefit determination, an indication of said benefit to said address indicating origination of the said associated customer identification and purchase data at said central incentive computer system.

35. The process of claim 34 further comprising:
storing an account for a retailer identifying credits due to said retailer and an account for a promoter identifying debits owed by said promoter in a database of accounts associated with said central incentive computer; and
crediting said account of said retailer and debiting said account of said promoter at said central incentive computer system.

36. The process of claim 34 wherein said retail POS system and said central incentive computer system communicate over a communications system comprising at least one member of the group consisting of network connections, Internet connections, wireless connections, telephone connections, and modem connections.

37. The process of claim 34 wherein said selection criteria comprise value of a purchase identified in said purchase data.

38. The process of claim 34 further comprising applying said benefit to a purchase associated with said customer identification and said purchase data at said retail POS system.

39. The process of claim 38 wherein said benefit is a coupon printed by said retail POS system.

40. The process of claim 38 wherein said benefit is a discount applied to said purchase.

41. The process of claim 34 further comprising determining said customer identification from one of a debit card reader, credit card reader, drivers license card reader, loyalty card reader, smart card reader, retinal scan reader, fingerprint analysis reader, voice analysis reader, and image analysis reader at said retail POS system.

42. The process of claim 34 wherein said central incentive computer system is collocated with a financial system and said retail POS system communicates with said central incentive computer system through a communications system linked to said financial system.

43. The process of claim 42 further comprising:
authorizing credit to a customer at a credit authorization system of said financial system; and
debiting a customer's financial account in response to said benefit determination at a financial institution.

44. The process of claim 34 further comprising transmitting a purchasing incentive specification to said central incentive computer system from an incentive issuing system coupled to said central incentive computer system.

45. The process of claim 44 wherein said incentive issuing system and said central incentive computer system communicate over at least one member of the set of network connections, Internet connections, wireless connections, telephone connections, and modem connections.

46. The process of claim 44 wherein said incentive issuing system supports manual entry of purchasing incentive specifications.

47. The process of claim 44 wherein said purchasing incentive specification is associated with a customer identification.

48. The process of claim 47 further comprising receive a signal transmitted from a transmitting television set top box at said incentive issuing system.

49. The process of claim 44 further comprising notifying an individual associated with said customer identifier of purchasing incentive offers via an Internet service at said incentive issuing system.

50. The process of claim 49 wherein said Internet service comprises a world wide web site.

51. The process of claim 49 wherein said Internet service comprises electronic mail.

52. The process of claim 44 further comprising transmitting said purchasing incentive specification in response to a non Web based transmission and a request for a Web page associated with a customer identification at said incentive issuing system.

53. The process of claim 44 further comprising selecting promotional incentives to offer based upon a shopping history stored in association with said customer identification at said incentive issuing system.

54. The process of claim 44 further comprising selecting promotional incentives to offer based upon a history of use of an automated kiosk associated with said identification number at said incentive issuing system.

55. The process of claim 44 wherein said purchasing incentive criteria is associated with a class of customers.

56. The process of claim 55 wherein said class comprises customers with residences in a certain geographic area.

57. The process of claim 55 wherein said class comprises customers making a specified amount of purchases in a specified time period.

58. The process of claim 55 wherein said class comprises customers who have not made purchases during a specified time period.

59. The process of claim 34 further comprising transferring funds between a retailer's account and a promoter's account by transferring a value of incentive benefits provided to a customer from said promoter's account to said retailer's account at said central incentive computer system.

60. The process of claim 34 wherein said selection criteria comprises purchase of a product.

61. The process of claim 34 wherein said selection criteria comprise purchase of a specified combination of products.

62. A process for providing purchasing incentives, comprising:
storing purchasing incentive specifications in a database of a central incentive computer system;
determining purchasing incentives to provide to a customer based upon a customer identifier associated with said customer and information stored in said database;
applying a benefit associated with said purchasing incentives to said customer;
determining said customer identifier at at least one of a plurality of retailer POS systems, wherein one or more of said plurality of retailer POS systems are not part of a single retail chain;
generating an electronic description of customer purchase selections at said at least one of said plurality of retailer POS systems; and
communicating to said central incentive system said electronic description of customer purchase selections at said at least one of said plurality of retailer POS systems.

63. The process of claim 62 wherein said benefit is a credit of purchase reward points credited to said customer, said purchase reward points based upon said electronic description of customer purchase selections.

64. The process of claim 62 wherein said benefit is a credit applied to a payment account associated with said customer.

65. The process of claim 62 further comprising transferring funds between a retailer's account and a promoter's account by transferring a value of promotions provided to a customer from said promoter's account to said retailer's account at said central incentive system.

66. A process for providing purchasing incentives, comprising:
selecting purchasing incentives to provide to a customer based upon a customer identifier associated with said customer and information stored in a database of a central incentive computer system;
transmitting said purchasing incentives to a plurality of retailer POS systems from said central incentive computer system; and
determining said customer identifier at at least one of said plurality of retailer POS systems, wherein one or more of said plurality of retailer POS systems are not part of a single retail chain.

67. A storage medium storing a program for performing the steps recited in one of claims 34-66.
